(19) United States
(12) Patent Application Publication
(10) Pub. No.: US 2011/0043088 A1
(43) Pub. Date: Feb. 24, 2011

(54) Composite pedestal cabinet

(76) Inventors: Anthony McConnell, Zeeland, MI (US); Randolph Woellper, Hudsonville, MI (US)

Correspondence Address: FLYNN, THIEL, BOUTELL & TANIS, P.C., 2026 RAMBLING ROAD, KALAMAZOO, MI, 49008-1631, US

(21) Appl. No.: 12/806,673

(22) Filed: Aug. 18, 2010

Related U.S. Application Data
(60) Provisional application No. 61/274,515, filed on Aug. 18, 2009.

(51) Int. Cl. A47B 88/04; A47B 96/00; B23P 15/00

(52) U.S. Cl. 312/334.7; 312/294; 29/428

(57) ABSTRACT

A composite pedestal cabinet is provided which is formed of a foldable housing blank that defines a plurality of walls of the storage cabinet and has wall sections integrally joined together at fold lines. The cabinet blank is initially formed in an unfolded, flat condition and then the wall sections are folded about the fold lines and interlocked together to define a plurality of walls of a box-like housing. Additional support structures are provided on the cabinet housing for supporting door slides and their associated drawers, as well as a top wall and casters.

### CROSS REFERENCE TO RELATED APPLICATION

This application claims the benefit of U.S. Provisional Application No. 61/274 515, filed Aug. 18, 2009, the disclosure of which is hereby incorporated by reference in its entirety.

### FIELD OF THE INVENTION

The invention relates to a file storage cabinet, and more particularly, to a storage cabinet having a foldable composite cabinet body from which a plurality of the cabinet walls are constructed.

### BACKGROUND OF THE INVENTION

Conventional storage cabinets for the office include various types of storage cabinets including vertical file cabinets, lateral file cabinets, and pedestal cabinets. Typically, such cabinets are formed of multiple separate panels that are joined together at respective corners into a box-like housing construction. This cabinet housing then has a plurality of drawers or the like movably mounted thereto in a conventional configuration.

With such cabinets, it is necessary to assemble the separated walls together at their respective corners, typically through use of a plurality of fasteners and fastening structures at the corners so as to form the box-like housing. The use of these multiple, separate components requires multiple steps in the assembly of the box-like housing. Further, either before or after assembly of these components, it also is necessary to finish the individual wall panels such as through the application of powder coating, painting or the like. As such, assembly of the box-like housing requires multiple steps typically including significant manual labor in completing the assembly process.

It is an object of the invention to form a finished cabinet housing which minimizes the steps in assembling a housing to which additional movable storage components such as drawers are then mounted.

The invention relates to a composite pedestal cabinet wherein a plurality of the walls of the cabinet are formed from a single sheet-like cabinet blank or pattern. This cabinet blank is formed of a suitable substantially rigid substrate which is covered on at least one side by a suitable finish layer such as a bladder-wrap vinyl material which defines the aesthetic finished appearance of the cabinet body and also serves to function in combination with the substrate to define a living hinge and thereby form fold lines about which the substrate material may be folded into a box-like configuration. The interior side of the housing blank preferably is V-grooved along the desired fold lines to facilitate folding of the housing walls and join the housing walls together at the corners in a typical right-angle corner configuration. Preferably, the composite blank is constructed so that portions thereof define the back wall, opposite side walls and the bottom wall of the cabinet housing. These various wall sections are then folded appropriately at the corners of the cabinet housing and interlocked together so as to maintain a box-like configuration which is enclosed on at least four sides, namely the opposite sides, back and bottom.

The material of the housing blank is of a suitable rigid material which is able to maintain its planar shape and allow for the V-grooving at the fold line. Further, the housing blank is provided with additional thickness at least in the regions of the side walls to define reinforcement ribs and mounting locations which are structurally rigid and solid so as to suitably support telescoping drawer slides thereon which slides are configured to mount conventional drawers on the side walls. Further, the side walls may be provided with additional support formations formed as bosses to serve as caster mounts at the bottom edges thereof which are able to rigidly support and engage with downwardly projecting casters or rollers. The casters each include a mounting shaft that projects upwardly and is engaged with the caster mounts. In this manner, the side walls not only carry the loads of the drawers, but also the loads of the overall weight of the entire cabinet including the drawers.

Further, the invention relates to the method of forming a cabinet housing using this construction wherein a substrate is formed in a predefined shape that forms a plurality of the walls of the cabinet housing. This substrate is then preferably covered or finished on at least an exterior side such as by being bladder wrapped with a finish layer or provided with a metal layer such as a foil/metal layer laminated to the substrate. The layer can be any foldable, conformable material. Even a sprayed material could be suitable. For bladder wrapping, any overhanging portions of this finish layer are then trimmed about the substrate edges and openings and the substrate is put through a material removal process such as V-grooving to remove material along the fold lines and permit folding of the various wall sections into a box-like housing.

It is noted that the drawer slides preferably are mounted to the side wall portions of the housing blank when the housing blank is in a flat, unfolded condition which facilitates assembly since such assembly of the drawer slides may be conducted with the housing blank laid on a work table or the like. While still positioned on this work table, the various wall sections may then be folded to a final position and interlocked together through appropriate adhesives and/or locking formations formed in the housing blank. Thereafter, the casters may then be engaged with the caster mounts formed in the housing blank to form a housing sub-assembly and then the housing sub-assembly may be oriented to an upright configuration for subsequent mounting of the drawers thereto. Additionally, in the preferred embodiment, the top wall of the cabinet housing is formed separate from the housing blank and once the housing sub-assembly is formed, the top wall is then mounted thereto. After mounting of the top wall and installation of the drawers, the storage cabinet preferably is in a completed configuration. This completed configuration is formed through a minimal number of steps, greatly simplifying the assembly process.

Other objects and purposes of the invention, and variations thereof, will be apparent upon reading the following specification and inspecting the accompanying drawings.

### DESCRIPTION OF THE DRAWINGS

FIG. 1 is a front perspective view of a composite pedestal cabinet.

FIG. 2 is a side perspective view of the cabinet.

FIG. 3 is a front perspective view of the cabinet in a partially assembled condition.

FIG. 4 is an exploded front perspective view of the storage cabinet.

FIG. 5 is a plan view of a cabinet housing assembly in an unfolded condition.

FIG. 6 is a plan view of a housing blank illustrating the interior side thereof.

FIG. 7 is a plan view of the housing blank illustrating the exterior side thereof.

FIG. 8 is a diagrammatic assembly view showing the housing blank being folded.

FIG. 9 is a diagrammatic view of the housing blank with bottom panels and a side wall being folded upwardly.

FIG. 10 is a diagrammatic bottom view of the housing blank being folded.

FIG. 11 diagrammatically illustrates the side walls being folded inwardly together.

FIG. 12 is a partial end view of the locking structure joining two bottom panel sections together.

FIG. 13 illustrates a drawer slide being fastened to a side wall.

FIG. 14 illustrates an alternate mounting arrangement for the drawer slide.

FIG. 15 is a partial view illustrating a caster mounted on the side wall.

FIG. 16 is a perspective view illustrating an alternate cabinet construction.

FIG. 17 is a diagrammatic assembly view showing folding of the cabinet blank for the alternate cabinet construction.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

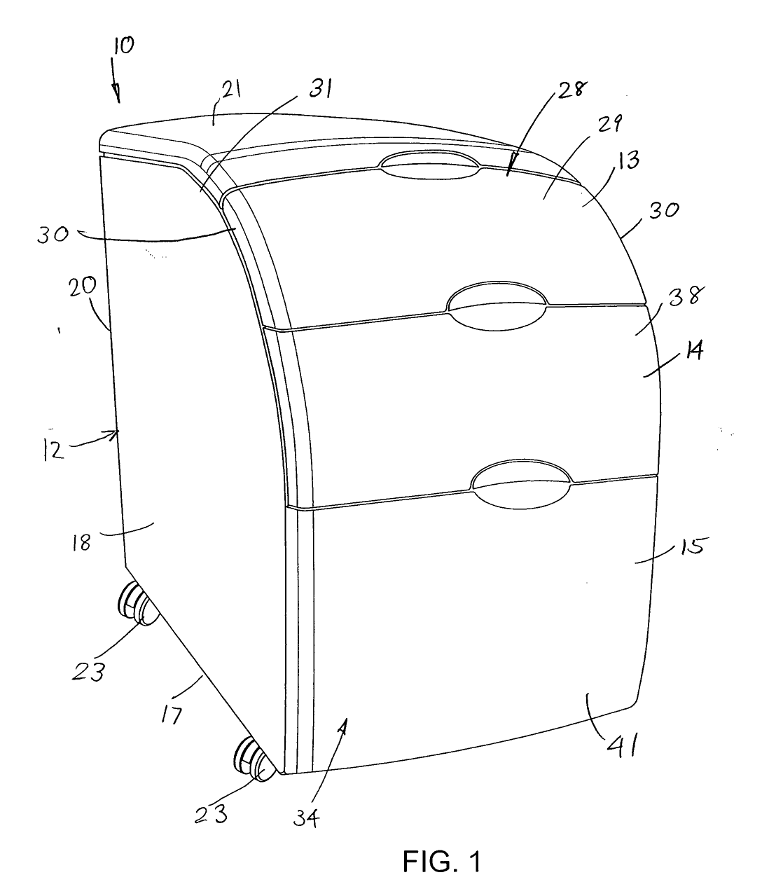

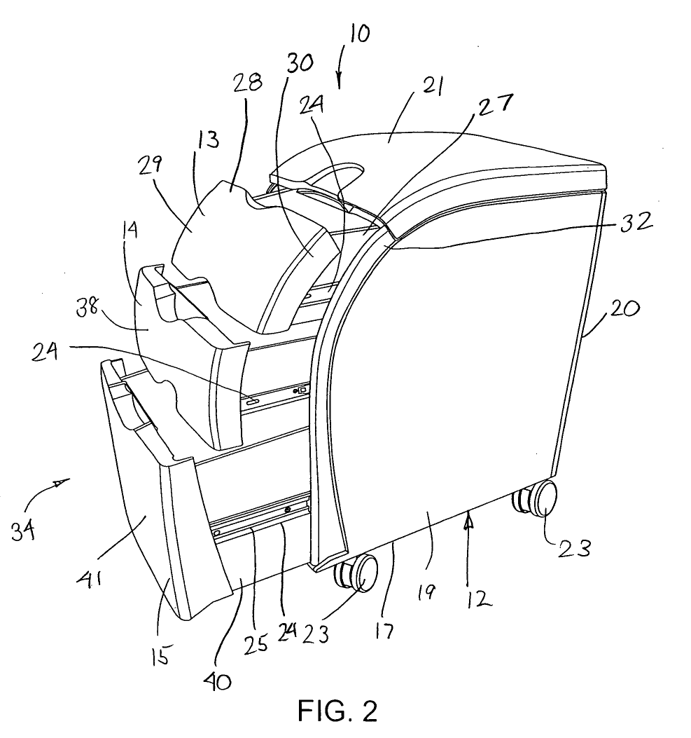

The invention relates to a storage cabinet 10 which comprises a box-like cabinet housing 12 having a plurality of openable drawers 13-15 which are slidably supported on the cabinet housing 12 and movable between the retracted position of FIG. 1 and a fully extended position wherein the drawers 13-15 are shown partially extended in FIG. 2.

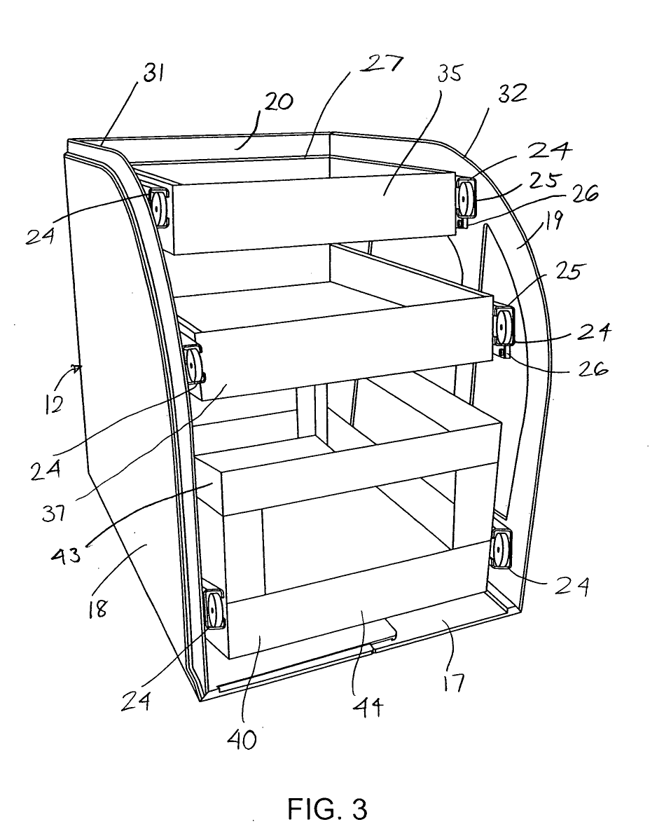

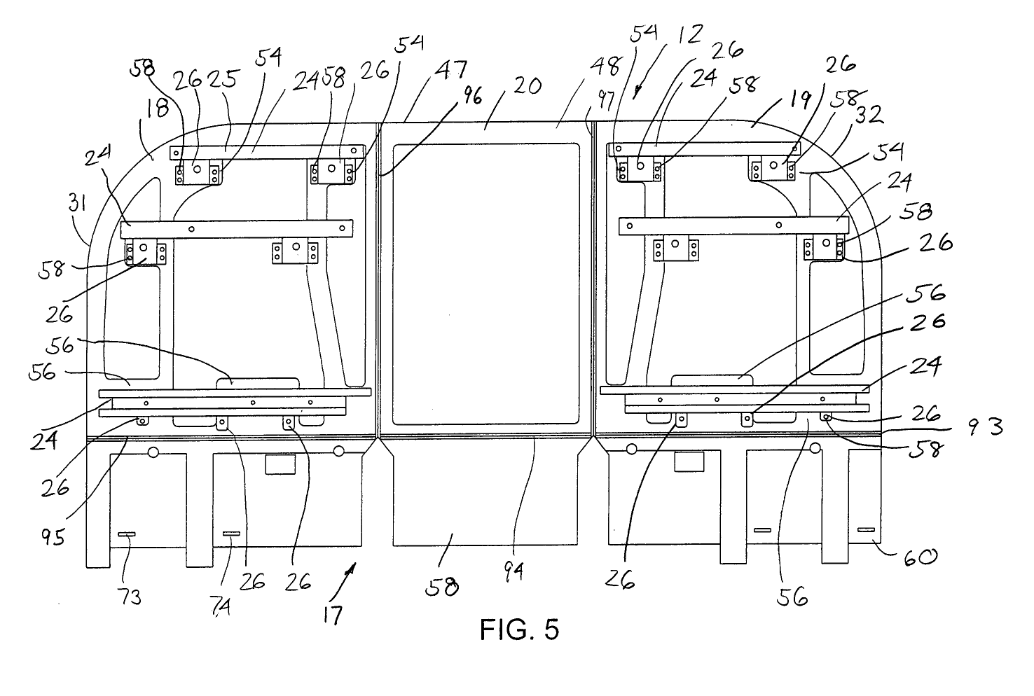

Generally, the cabinet housing 12 comprises a bottom wall 17, opposite side walls 18 and 19 and a back wall 20. The cabinet 10 further includes a top wall 21 which may be formed separate from the remainder of the cabinet housing 12 as generally illustrated in the embodiment of FIGS. 3-5 but may also be provided integral with the remainder of the cabinet housing 12 as depicted in phantom outline in FIG. 6. The specific construction of the top wall 21 will be discussed in further detail hereinafter. Generally, the cabinet housing 12 of the inventive storage cabinet 10 has a composite panel structure wherein a plurality of the cabinet walls 17-20 are joined together during the manufacturing process at their respective corners. The various interconnected walls are initially formed in a flat condition (FIG. 5) and then folded into the box-like shape generally illustrated in FIGS. 1 and 2.

Once the cabinet housing 12 is assembled, appropriate casters 23 are mounted at the four bottom corners of the cabinet housing to support the storage cabinet 10 in rolling engagement with a floor surface. It is understood that other support structures could be provided such as fixed legs.

As to the drawers 13-15, these drawers 13-15 generally use common components and have a construction which is substantially similar to conventional drawers. These drawers comprise a plurality of telescoping drawer slides 24 which are mounted in pairs to the respective side walls 18 and 19 as can be seen in FIG. 3. Referring to FIG. 5, each of the drawer slides 24 generally include a rail section 25 which is comprised of telescoping, extendable rails and mounting brackets or flanges 26 thereon by which the drawer slide 24 is mounted its respective side wall 18 or 19. While all of the drawer slides 24 are designated by the same reference numeral 24, it can be seen in FIG. 5 that these drawer slides 24 need not be identical to each other in that they may vary in the longitudinal length and overall size as can be seen by the top two drawer slides 24 in FIG. 5, and also may have an alternate configuration as evidenced by the bottommost drawer slides 24 which support the bottom drawer 15. The drawer slides 24 all have a conventional construction and different variations of these types of telescoping door slides are readily available from various door slide manufacturers.

As to the specific construction of the drawers 13-15, these drawers 13-15 have different configurations. For example, the top or upper drawer 13 is illustrated in FIG. 3 as comprising a drawer box 27 which is enclosed on four sides and the bottom and opens upwardly wherein the side walls of the drawer box 27 are supported on the respective pair of uppermost drawer slides 24.

Referring to FIG. 2, the drawer box 27 further includes a front drawer panel 28 mounted thereto which panel 28 is defined by a front wall 29 and opposite side walls 30 which extend rearwardly and fit over the peripheral edges 31 and 32 of the cabinet side walls 18 and 19.

Notably with respect to the advantages provided by the cabinet housing 12, the side walls 18 and 19 are provided with a curvature on the wall edges 31 and 32 to provide a unique non-rectangular shape to the storage cabinet 10. As such, the drawer front panel 28 is curved in the vertical direction and side to side so that the storage cabinet 10 has an overall curved cabinet front 34 to provide a unique aesthetically pleasing configuration for the storage cabinet 10. While the drawer box 27 has a vertical upright front wall 35 so that the interior shape of the drawer box 27 is rectangular, the front drawer panel 28 has mounting structure on the inside face thereof which mounts to the drawer box 27 to allow for the transition between the upright front box wall 35 and the curved front wall 29 of the drawer panel 28.

As to the intermediate drawer 14, this drawer 14 has substantially the same construction as that described above relative to the top drawer 13. In particular, the intermediate drawer 14 includes a drawer box 37 having a rectangular configuration which is supported by the intermediate drawer slides 24 as seen in FIG. 3. The drawer 14 further includes a front drawer panel 38 as seen in FIGS. 1 and 2 which mounts to the drawer box 37 in a manner similar to the mounting of the top drawer panel 28 to its respective drawer box 27. Notably, the door slides supporting the top drawer 13 have a shorter horizontal length than the drawer slides 24 supporting the intermediate drawer 14 which dimensional difference thereby accommodates the curvature of the drawer front 34.

As to the bottom drawer 15, this bottom drawer 15 is illustrated in FIGS. 2 and 3 as having a drawer box 40 that is mounted on the lowermost pair of drawer slides 24. This drawer box 40 has the front drawer panel 41 mounted thereto. The drawer box 40 is substantially similar to the above-described drawer box except that it has a greater vertical dimension defined by a lower box section 44 and an upper support frame 43 that projects upwardly of the box section 44. The upper support section 43 is configured so as to support hanging folders in other similar file dividers thereon in a conventional manner.

It is noted that the lower most drawer slides 24 have a longer horizontal dimension as compared to the intermediate drawer slides 24 and the uppermost drawer slides 24 which have a shorter length. Due to the curvature of the wall edges 31 and 32 as defined on the side walls 18 and 19, it is possible to thereby have the drawers 13-15 stepping rearwardly one above the other to accommodate this curvature. As can be seen in FIG. 1, the front drawer panels 30, 38 and 41 thereby define a continuous curvature and also have a common curvature extending laterally from conventional storage cabinets which have a standard rectangular, box shape.

Referring to FIG. 5, the cabinet housing 12 has a composite construction which includes a housing blank 47 which defines a plurality of the cabinet walls 17-20. The illustrated embodiment of FIG. 5 does not include the top wall 21 formed integrally therewith but it could be formed so as to include such top wall 21 as generally indicated in phantom outline in FIG. 6. The cabinet blank 47 includes the various door slides 24 mounted thereon when in the flat configuration of FIG. 5 and also is foldable to allow for subsequent orientation of the various walls 17-20 into a normal box-like configuration as will be described in further detail hereinafter relative to the assembly process. Generally as illustrated in FIGS. 8-11, the cabinet blank 47 is foldable to form the box-like cabinet housing 12.

Turning more specifically as to the cabinet blank 47, this blank 47 is illustrated in FIGS. 5 and 6 in the flat unfolded condition resulting from the manufacturing process.

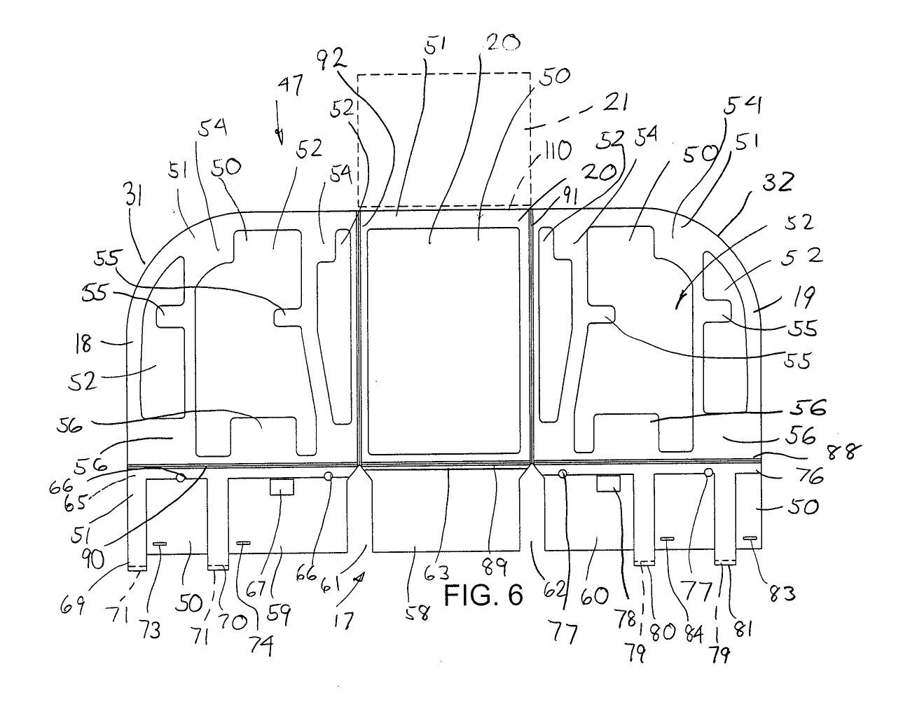

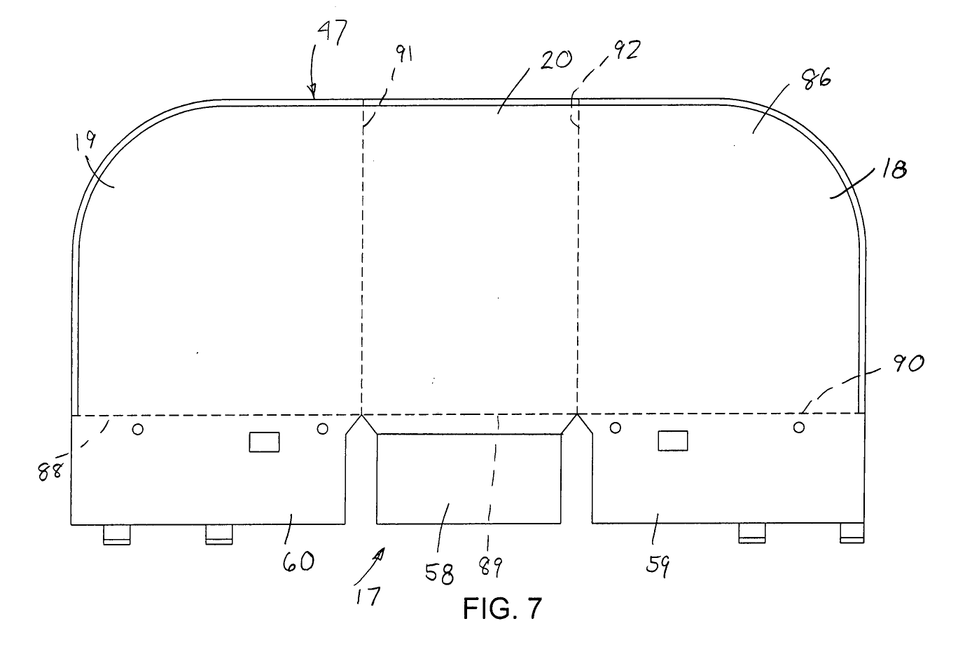

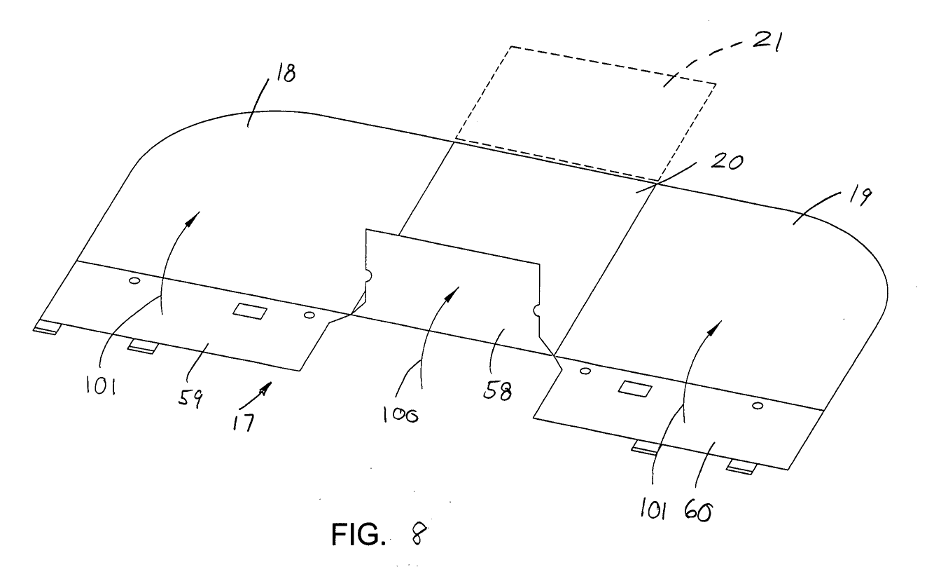

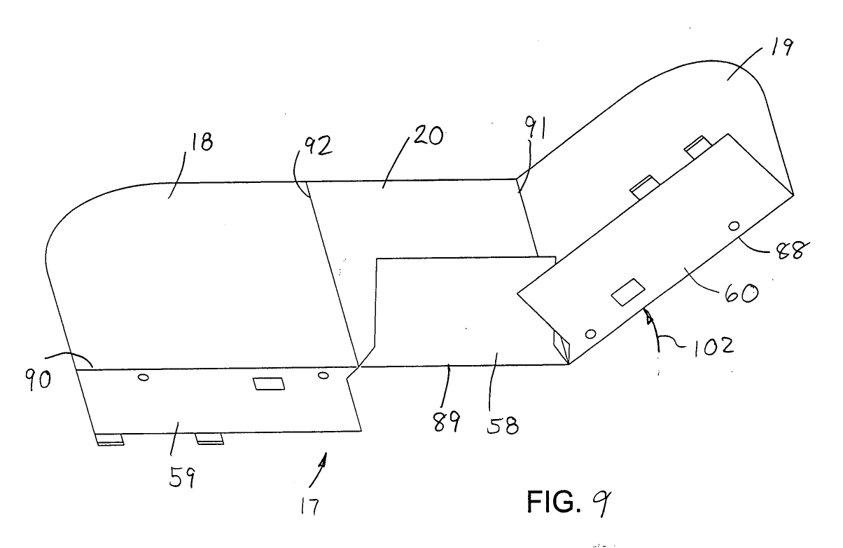

More particularly, the cabinet blank 47 may include a rigid substrate 48 having an interior side as seen in FIG. 6 and an exterior side as seen in FIG. 7. This substrate 48 typically is provided as a stock material generally in rectangular form without any of the structures of the cabinet housing being formed therein. For example, the rigid substrate 48 may be formed from a sheet of a suitable rigid material such as a hardboard although it could be formed from any other suitable rigid material such as molded plastic, a plastic sheet, thin concrete material, medium density fiber board, particle board, spaceboard, plywood or other sheet material such as plastic or metal or a combination thereof. The substrate 48 preferably is selected to provide optimum conditions of rigidity and strength as well as cost effectiveness which may provide an improvement over thin sheet metal which is conventionally used in typical storage cabinets.

Preferably, the rigid substrate 48 is provided as a stock material having an initial rectangular shape, which initial shape is then cut or shaped so as to define the specific outline illustrated in FIGS. 6 and 7. This specific outline of the rigid substrate 48 generally comprises sections of the bottom wall 17, the side walls 18 and 19 including the curved shape of their respective edges 31 and 32, and the rectangular shape of the back wall 20.

While the rigid substrate 48 may be provided with a constant thickness throughout, the illustrated embodiment seen in FIG. 6 has a variable thickness wherein an additional layer of a secondary substrate material may be provided in combination with a primary layer. More particularly, the primary substrate layer 50 may define the entire shape of the shaped substrate 48 while a secondary layer 51 may be formed on the inside face of the primary layer 50 and has a unique pattern which defines various interior reinforcement and/or mounting structures of the cabinet housing 12. Hence, the rigid substrate 48 may be formed by adhering the primary layer 50 and the secondary layer 51 together although other methods of providing the primary layer and secondary layer 50 and 51 may also be used. As such, the primary layer 50 and the open regions of the secondary layer 51 such as open interior region 52 would define a relatively thin thickness while the secondary layer 51 would provide thicker portions of the rigid substrate 48. These increased thickness regions of the combined primary layer 50 and secondary layer 51 serve to thereby define a plurality of upper mounting structures or formations 54, intermediate mounting structures 55 and lower mounting structures 56 which are all adapted to support respective ones of the drawer slides 24 thereon. The substrate layers 48 also could be formed through molding as a single integral piece.

In particular, the upper mounting structures 54 have an increased thickness defined by the combined thickness of the primary and secondary layers 50 and 51 and thereby allow for positioning of the drawer slide brackets 26 adjacent thereto and then insertion of appropriate fasteners 58 which engage into these mounting structures 54. Similarly as to the intermediate drawer slides 24, these drawer slides have the brackets 26 thereof mounted to their respective mounting structures 55 by the fasteners 58. Still further, the lowermost drawer slides 24 also have their respective brackets 26 positioned adjacent their respective mounting structures 56 for securement thereto by the fasteners 58. As such, the secondary layer 51 not only provides reinforcement to the inner primary layer 50, but also serves to define any additional physical structures which project interiorally of the primary layer 50. In this manner, the various drawer slides 24 are readily mounted to the respective side walls 18 and 19.

As to the back wall 20 illustrated in FIG. 6, this back wall 20 is formed substantially by the primary substrate layer 50 wherein the secondary layer 51 defines a generally rectangular frame that extends about the periphery of the back wall 20 to provide rigidity to the peripheral edges thereof.

As to the bottom wall 17, this bottom wall 17 is comprised of three wall sections 58-60, namely center section 58 as well as side sections 59 and 60. The various side sections 59 and 60 and the intermediate center section 58 are joined to the side walls 18 and 19 as well as the back wall 20 along common edges extending therebetween but the center section 58 is separated on opposite sides from the side sections 59 and 60 by gaps or slots 61 and 62.

As to the center section 58, this center section 58 generally has a thin thickness corresponding to the primary layer 50 but also has a thicker section 63 along the common edge with the back wall 20 due to the combined thickness of the secondary and primary layers 51 and 50.

As to the side section 59, this side section 59 also has a substantially thin thickness corresponding to the primary layer 50 but also has a pattern of the secondary layer 51 applied thereto. This secondary layer 51 has a longitudinal thick section 65 extending along the common edge with the side wall 18 wherein two through bores 66 are provided therealong. Further, an additional locator flange 67 is provided which is adapted to receive an edge of the center section 58 therein as will be described in further detail hereinafter.

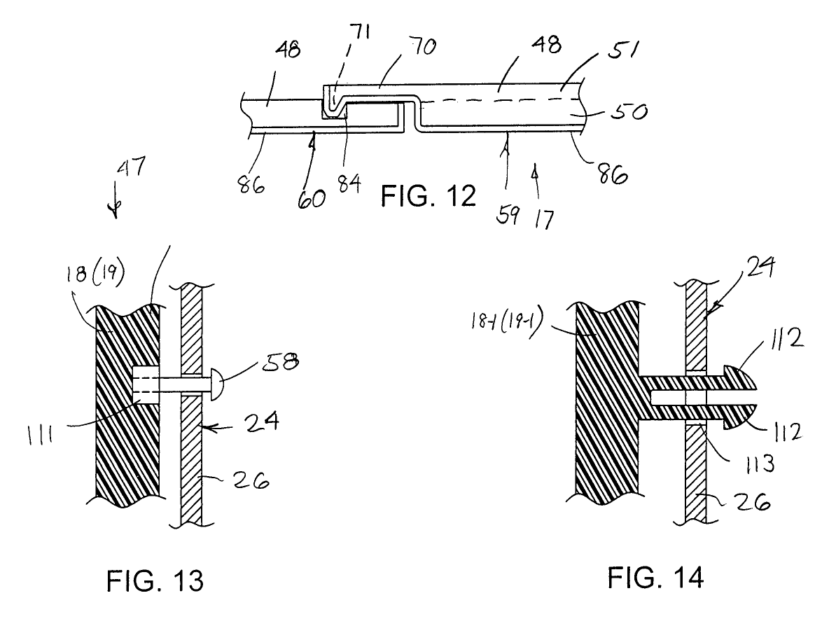

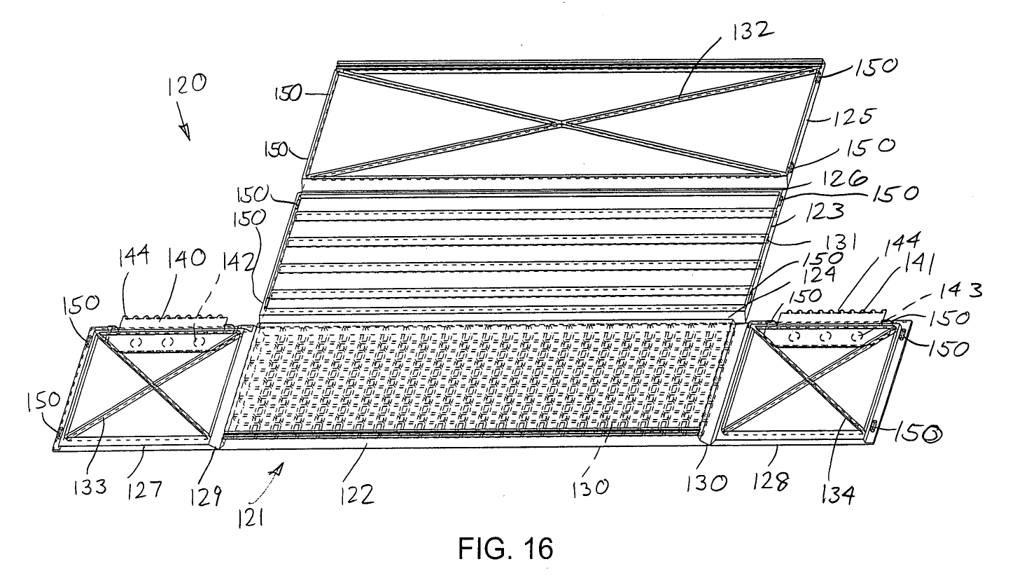

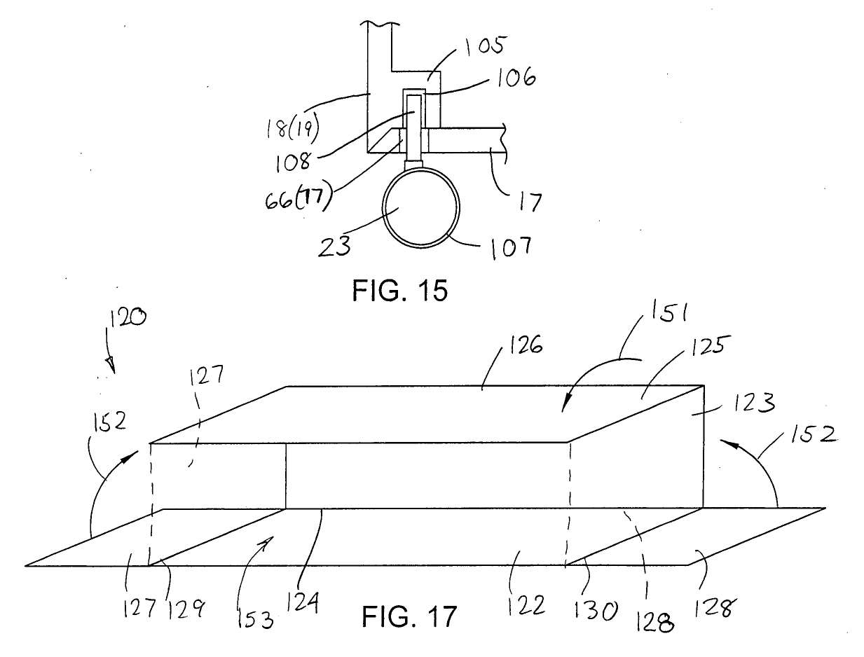

Still further, the secondary layer 51 also defines a pair of locking flanges 69 and 70 which project outwardly and have engagement ribs 71 on the distal end thereof. The structure of this locking flange 70 is illustrated in further detail in FIG. 12. The thin portion of the side section 59 as defined by the primary layer 50 further includes a pair of recessed slots 73 and 74.

As to the other side section 60, this side section 60 is formed similarly in that it includes a thick edge section 76, through holes 77 and a locator flange 78. Still further, a pair of locking flanges 80 and 81 are provided which are similar to the locking flanges 69 and 70 in that they include engagement ribs 79 on the distal end thereof. The locking flanges 80 and 81 are spaced apart from each other and are adapted to align with and snap fit into the corresponding slots 73 and 74 formed in the opposite side section 59 as will be described in further detail herein. Adjacent to the locking flanges 80 and 81, a pair of recessed slots 83 and 84 are also provided which are adapted to lockingly engage the corresponding locking flanges 69 and 70. While this interlocking of the flanges and corresponding slots will be described in further detail herein relative to the assembly operation, FIG. 12 illustrates the locking flange 70 and its corresponding rib 71 being lockingly engaged with a corresponding slot 84 formed in the side section 60.

Once the rigid substrate 48 is formed with the above-described structural formations, preferably the rigid substrate 48 is thereby finished, at least on the exterior surfaces thereof which is the exposed side generally illustrated in FIG. 7. While the substrate 48 may be selected of a suitable material, such as molded plastic, which provides an inherent finish thereto, the use of a hardboard or other similar unfinished substrate typically does not provide an aesthetically pleasing, exposed surface that could be used for the exposed face of the cabinet housing 12. As such, the substrate 48 preferably is subjected to a finishing process whereby at least these exposed faces or the exposed side of the substrate 48 as seen in FIG. 7 is provided with a layer of a finish material 86 which is generally depicted in FIGS. 7 and 12. Such finish layer 86 in a preferred embodiment could be a bladder wrapped vinyl material which would overlie all of the exposed exterior faces of the substrate 48 as can be seen in FIG. 12 but also would not necessarily cover the inside face of the substrate 48. In this manner, the vinyl finish layer 86 defines the exposed finish layer of the face of the storage cabinet 10. Other finish layers 86 may also be provided wherein the substrate 48, for example, could be powder coated or coated by other finishing techniques. If bladder wrapped, the material may extend by and the edge of the substrate 48 and over any openings therein, such that such excess would be trimmed in a trimming operation.

After the substrate 48 is provided with the finish layer 86 and trimmed where necessary, the composite cabinet blank 47 is partially formed.

Thereafter, the cabinet blank 47 undergoes a material removal process or a machining process or even molding process so as to define fold lines 88-92 (FIG. 7) about which the various walls 18, 19, and 20 and the bottom wall sections 58-60 may be folded into the box-like configuration. Hence, the V-shaped groove may come from initial formation such as by molding, or may formed by a secondary operation such as a material removal process.

More particularly as to FIGS. 5 and 6, these fold lines 88-92 are formed by V-grooving the common edges disposed between each of the walls 18-20 and the bottom wall sections 58-60. For example, the fold line 88 between the bottom wall section 60 and the side wall 19 is defined by the V-groove 93 (FIG. 5) that is formed along the common edges between this bottom wall section 60 and the side wall 19. Similarly, the fold line 89 is defined by a V-groove 94 (FIG. 5) between the bottom center section 58 and the back wall 20. Additional V-grooves 95-97 are provided to define the respective fold lines 90, 92 and 91. Preferably, this V-grooving process and the various V-grooves 93-97 are provided in those regions of the substrate 48 which have a maximum thickness defined by the combined thicknesses of the primary and secondary layers 50 and 51. The V-grooving is effected to a depth which still leaves a layer of thickness in the substrate 48 as well as the finish layer 86 to essentially define a living hinge at each of the V-grooves 93-97 and allow for relative folding of all of these wall sections as generally depicted in FIGS. 8-11. These grooves allow for provision of adhesive, or could be formed with collapsible ribs or other formations that are heated to effect melting and achieve bonding in the groove as the melted material solidifies.

Once the cabinet blank 47 is formed as generally depicted in FIG. 6, the various drawer slides 24 may be fastened into place in the positions illustrated in FIG. 5. This fastening of the drawer slides 24 is accomplished with the cabinet blank 47 in the unfolded, flat condition of FIG. 5 and typically may be conducted upon a work table. In the flat condition, the opposite finished side of the cabinet blank 47 is illustrated in FIG. 7.

Once the cabinet blank 47 is provided, the box-like cabinet housing 12 may then be formed through suitable folding of the various wall sections of the blank 47. As to this assembly process, the bottom center section 58 preferably is first folded upwardly as indicated by reference arrow 100 to an upright vertical orientation. The side sections 59 and 60 of the bottom wall 17 similarly are folded upwardly to the vertical orientation as indicated by reference arrows 101.

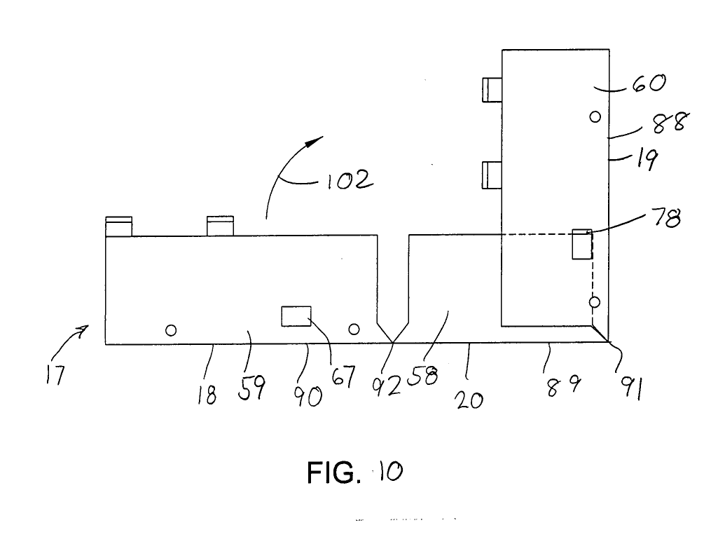

Referring to FIG. 9, the right side wall 19 is illustrated being folded upwardly to a vertical orientation as indicated by reference arrow 102. It is understood that bottom wall section 59 is shown in a flat condition for illustrative purposes but this section 59 would also be folded upwardly to the vertical position and then the left side wall 18 folded upwardly to the vertical orientation in the same manner indicated by reference arrow 102. During this folding step, referring to FIG. 10, the right side wall 19 is shown in the vertical orientation wherein the lower corner of the bottom wall section 60 overlaps and is disposed vertically below the center wall section 58. With the other bottom wall section 59 in the vertical orientation as illustrated in FIG. 10, the combination of the side wall 18 and the bottom wall section 59 are then pivoted upwardly to the vertical orientation about the fold line 92 as indicated by reference arrow 102 in FIG. 10.

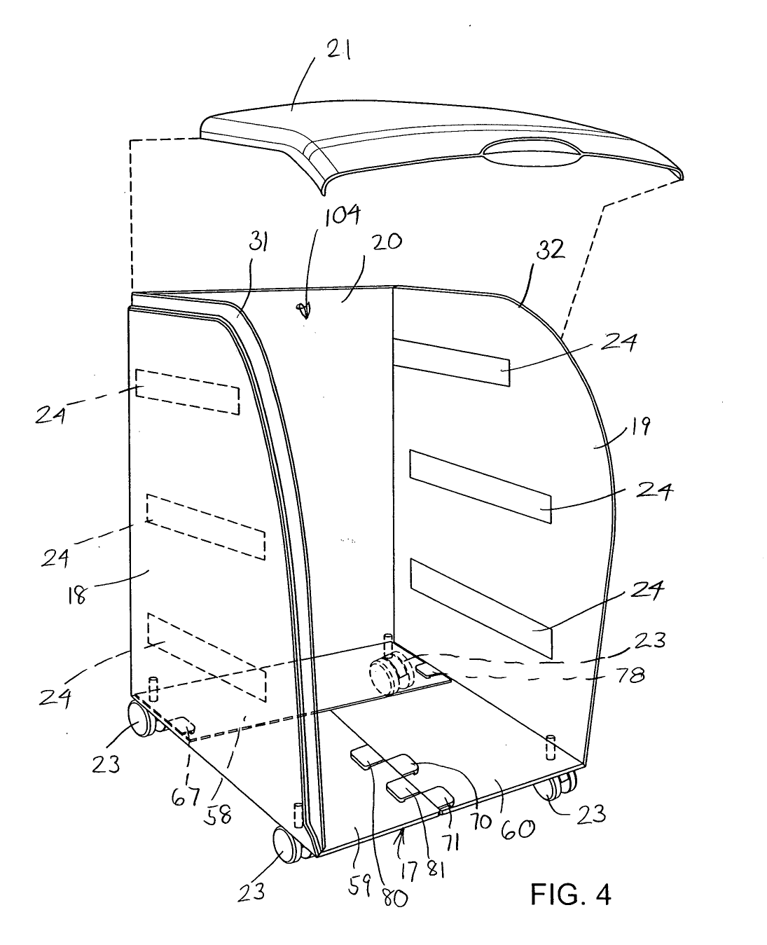

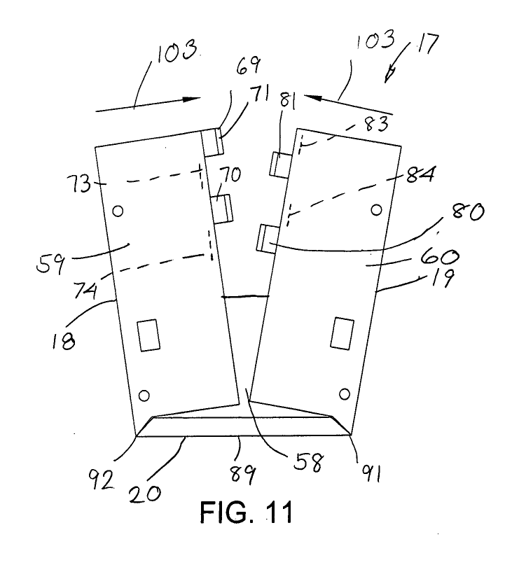

Referring to FIG. 11, the side wall 18 and the other side wall 19 may need to be tilted away from each other from the vertical orientation to allow interlocking engagement thereof. In particular, reference arrows 103 depict the side wall sections 59 and 60 being moved simultaneously together with their respective locking tabs 69 and 70 coming into alignment and then locking into engagement with the corresponding slots 83 and 84 while the other locking flanges 81 and 80 align with and lockingly engage the corresponding slots 73 and 74. Once the wall sections 18 and 19 are positioned in the vertical orientation, these various locking tabs 69, 70, 80 and 81 are lockingly inter-engaged with their respective slots 80, 81, 83 and 84 as generally depicted in FIG. 12. This prevents the bottom wall sections 59 and 60 from disengaging wherein the engagement of these wall sections 59 and 60 are depicted in further detail in FIG. 4.

Meanwhile the inner flanges 67 and 78 receive the adjacent edges of the bottom center section 58 therein as can be seen in FIG. 4 so as to prevent undesirable vertical movement or upward folding of this center section 58. As such, these various wall sections 58-60 interconnect together with each other to define a fixed bottom wall 17 as seen in FIG. 4. After this folding process is completed, the side walls 18 and 19 have the vertical orientation of FIG. 4 while the bottom wall 17 faces upwardly to define the interior compartment 104 of the cabinet housing 12. The drawer slides 24 are diagrammatically illustrated in FIG. 4 and are hence positioned for mounting of the various drawers 13-15 thereon during the final assembly process.

As to the casters 23, it is noted that the side walls 18 and 19 are each provided with an enlarged mounting block or boss 105 at each lower corner which is disposed directly above a respective one of the through holes 66 or 77. Each mounting block 105 in particular includes an interior bore 106 which is aligned in registry with its respective through hole 66 or 77. Thus, once the box-like cabinet housing 12 is formed as in FIG. 4 after the folding process, the caster 23 may then be fixedly attached to the mounting boss 105. In particular, the casters 23 each include a wheel 107 and an upright post 108 which post is frictionally engaged by inserting the post 108 first through its respective through hole 66 or 77 and then into tight fitting locking engagement with the corresponding bore 106. in the boss 105. Hence, these bosses 105 serve as caster mounts for mounting the casters 23 in the position generally illustrated in FIG. 4.

When performing the folding operation, preferably the V-grooves 93-97 also are provided with additional engagement means and preferably, are included with a suitable hot melted adhesive or other type of adhesive which rigidly secures together the opposing groove faces in the V-grooves 93-97 to rigidify the various corners of the cabinet housing 12.

Additionally, the top wall 21 is also then secured in place as generally depicted in FIG. 4 on the uppermost edges of the side walls 18 and 19 and the back wall 20. Attachment of this top wall 21 may be accomplished through a suitable adhesive, or by snap-locking formations on the cooperating edges of the top wall 21 and the edges of the side walls 18 and 19 and the back wall 20. As briefly referenced above, the top wall 21 is shown as a separate component but also may be formed as an additional integral portion of the cabinet blank 47 as depicted in phantom outline in FIGS. 6 and 8. This top wall 21 could be formed with substantially the same construction as the various wall structures previously described in the cabinet blank 47 wherein additional fold line 110 (FIG. 6) would be formed by V-grooving of the substrate material. This top wall 21 could then be folded over this fold line 110 so as to overlie the interior cabinet compartment 104 and be fixedly secured in place by suitable engagement structures such as snap fit connections or by separate fasteners. Preferably, however, the overall construction of the cabinet housing 12 minimizes the number of fasteners, and in the illustrated embodiment, the only fasteners required are fasteners 58 which attach the drawer slides 24 to the various mounting structures 54-56.

While the above-described cabinet blank 47 is disclosed as being formed of a hardboard or other similar material, it is noted that the cabinet blank 47 also could be formed of a molded plastic material or other similar material composition. Referring to FIG. 13, such a construction for the cabinet blank 47 could result in the same shape for the cabinet blank 47 as illustrated in FIG. 5 which has the varying thicknesses throughout. Also, the various wall structures such as the side walls 18 and 19 as seen in FIG. 13 could have a constant cross-sectional thickness which would depend upon achieving suitable strength while also minimizing material expenses. For a molded plastic construction such as illustrated in FIG. 13, additional metallic inserts 111 may be provided which are adapted to threadedly receive the drawer slide fasteners 58 therein.

Referring to FIG. 14, the side walls 18-1 and 19-1 may also be formed with snap-fit fingers 112 which project outwardly and replace the mechanical fasteners 58. These snap-fit fingers 112 could snap lockingly engage the corresponding hole 113 formed in the mounting flange 26 of the drawer slide 24 and allow for simple attachment of the drawer slides 24 to the side walls 18-1 and 19-1. Here again, these molded side walls 18-1 and 19-1 could be provided with a constant thickness throughout or be formed with suitable ribs such as the various strengthening structures illustrated in FIG. 5. also, the drawer slide 24 can be molded in place to secure the drawer slides 24 to the side walls.

Generally, the invention relates to the overall structural arrangement of the cabinet housing 12 and the composite structure thereof. The invention also relates to the overall method of forming this composite cabinet structure.

This method includes the steps of providing a suitable substrate to define a plurality of walls and then providing a suitable finished appearance to this substrate. This finished appearance may include the step of providing an additional finish layer to an exposed exterior surface of the substrate. Additionally, the method includes the step of forming fold lines in the substrate such as by mechanical machining or material removal, such as through V-grooving. A V-grooving process forms V-grooves within the substrate material and hence defines fold lines about which the various wall sections may be folded. Additionally, the method includes the step of mounting any support structures therein such as by fasteners wherein the preferred cabinet housing 12 includes the mounting of separate telescoping drawer slides 24 to the inside faces of side walls 18 and 19.

The mounting of the drawer slides may be accomplished with the drawer blank 47 in a flat condition, after which, the wall sections are then folded about respective fold lines into a box-like configuration as seen in FIG. 4. Thereafter, the additional casters or support members may be mounted to the bottom of the cabinet housing 12, while additional storage structures such as the cabinet drawers 13-15 are then mounted to the drawer slides.

As such, with this method of assembly and construction, a storage cabinet 10 may be formed with a minimal amount of manual labor involved in forming and assembling a box-like housing and mounting the cabinet components thereto. This method essentially minimizes the number of components and also minimizes the number of fasteners required for affixing the various components to the wall sections.

Using the principles of the above-described invention, an additional storage cabinet 120 is illustrated. This storage cabinet 120 comprises a cabinet blank 121 which comprises a bottom wall 122, a back wall 123 joined thereto by a fold line 124, and a top wall 125 joined to the back wall 125 by the respective fold line 126. Additionally, side walls 127 and 128 are joined to the bottom wall 122 by respective fold lines 129 and 130. Preferably, the cabinet blank 121 is formed of a molded plastic material so as to include various rigidifying structures therein such as a pattern of ribs 130 on the bottom wall 122, the pattern of channels 131 on the back wall 123, or the additional X-shaped pattern of ribs 132 formed on the top wall 125. Similar patterns of ribs 133 and 134 also may be formed in the respective side walls 127 and 128.

At the various fold lines 124, 126, 129 and 130, the cabinet blank 121, when formed of a molded material, may have V-shaped channels formed by V-grooving. If the cabinet blank 121 was formed of multiple layers of a substrate material, these various V-shaped channels may also be formed by a mechanical V-grooving process.

Once the cabinet blank 121 is formed, additional metal mounting brackets 140 and 141 may be mechanically fastened to the side walls 127 and 128 by fasteners 142 and 143. These mounting brackets 140 and 141 include rows of hooks 144 which have a conventional configuration adapted to hook into a vertical row of slots which slots typically are formed in space-dividing wall panels conventionally used in offices. Thus, the storage cabinet 120 is of a type which is a wall-mounted storage cabinet 120 that is adapted for mounting to such wall panel systems. The mounting brackets 140 and 141 preferably are formed of a rigid metal and secured in place by the respective fasteners 142 and 143 while the blank 121 is in the flat condition illustrated in FIG. 16.

To maintain the various wall sections in a box-like configuration, adjacent edges of the various wall sections are included with connector parts 150 which are thereby configured to interconnect with each other as the various edges of these wall sections are brought into engagement with each other.

More particularly as to FIG. 17, assembly of the cabinet housing 120 is accomplished in a similar manner to that described above. Namely, the back wall 123 is first folded upwardly to a vertical orientation relative to the bottom wall 122 as indicated by reference arrow 151 while the top wall 125 is then pivoted over to the horizontal orientation about fold line 126. Thereafter, the side walls 127 and 128 are pivoted about their respective fold lines 129 and 130 as indicated by reference arrow 152 to an upright vertical orientation to define a rectangular box which is open on the front side 153 thereof. Due to the interconnection of the connector parts 150, which preferably would be interlocking type snap lock connectors like the flanges described above, the storage cabinet 120 is formed in a relatively simple process and is readily mountable to a wall panel through the brackets 140 and 141.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. In a composite storage cabinet comprising a housing defined by a plurality of cabinet walls including a bottom wall, upright side walls, an upright back wall and a top wall which define an interior compartment for storage and an open side for permitting access to said interior compartment, said storage cabinet further including one or more closure members which are movably mounted to said cabinet walls by respective mounting hardware comprising the improvement wherein a plurality of said cabinet walls are defined by a thin housing blank formed of a plurality of interconnected wall portions wherein each of said wall portions corresponds to a respective one of said cabinet walls which is formed thereby, and wherein adjacent pairs of said wall portions are joined together along common edges by elongate edge-wise fold sections, said edge-wise fold sections each defining a respective fold line between a respective adjacent pair of said wall portions to permit folding of said housing blank from an unfolded condition wherein said wall portions are coplanar and a folded condition wherein said wall portions are folded about said fold lines to a box-like configuration having said open side, said housing blank comprising a rigid substrate, which defines said wall portions, and a finished face across said substrate on an exterior side thereof opposite to an interior face, said substrate having a variable thickness defined by thinner sections extending face-wise and thicker portions which project interiorly from said thinner sections to define mounting formations to which said mounting hardware is fixedly secured to thereby secure each said closure member to said housing blank.

2. The composite storage cabinet according to claim 1, wherein said mounting hardware is secured to said housing blank by threaded fasteners engaged with said mounting formations of said thicker portions.

3. The composite storage cabinet according to claim 2, wherein said mounting hardware is fixedly secured to said housing blank when in said unfolded condition and said respective closure member is mounted to said mounting hardware when said housing blank is in said folded condition.

4. The composite storage cabinet according to claim 1, wherein said finished face is defined by a thin layer of finish material applied to said substrate when in the planar, unfolded condition.

5. The composite storage cabinet according to claim 1, wherein said thicker sections define elongate reinforcement formations which rigidify and support the thinner sections.

6. The composite storage cabinet according to claim 5, wherein said reinforcement formations and said mounting formations are defined in said wall portions which define said side walls wherein the weight of said closure members is carried by said side walls.

7. The composite storage cabinet according to claim 6, wherein said closure members are defined by openable drawers which are disposed in said interior compartment and enclose said open side when in a closed position, said mounting hardware for said drawers comprising drawer slides which are mounted to said mounting formations of said side walls.

8. The composite storage cabinet according to claim 7, wherein said mounting formations include bosses which project interiorly of said thinner sections proximate said bottom wall, said storage cabinet further including support members which project downwardly of said bottom wall and include connectors projecting upwardly through said bottom wall into fixed engagement with said bosses, said bosses being disposed on said side walls.

9. The composite storage cabinet according to claim 1, wherein said substrate is defined by a first layer which defines said thin sections and extends across the width of each of said wall portions, and a second layer disposed interiorly of said first layer wherein said second layer has a geometric pattern which partially covers said first layer to define said thicker sections, said thicker sections defining said mounting formations and further defining elongate reinforcement formations which rigidify and support the thinner sections.

10. The composite storage cabinet according to claim 1, wherein said fold sections comprise edgewise grooves formed by V-grooving to define said fold lines and facilitate folding of said wall portions.

11. In a composite storage cabinet comprising a housing defined by a plurality of cabinet walls including a bottom wall, upright side walls, an upright back wall and a top wall which define an interior compartment for storage and an open side for permitting access to said interior compartment, said storage cabinet further including one or more closure members which are movably mounted to said cabinet walls by respective mounting hardware comprising the improvement wherein a plurality of said cabinet walls are defined by a thin housing blank formed of a plurality of interconnected wall portions wherein each of said wall portions corresponds to a respective one of said cabinet walls which is formed thereby, and wherein adjacent pairs of said wall portions are joined together along common edges by elongate edge-wise fold sections, said edge-wise fold sections each defining a respective fold line between a respective adjacent pair of said wall portions to permit folding of said housing blank from an unfolded condition wherein said wall portions are coplanar and a folded condition wherein said wall portions are folded about said fold lines to a box-like configuration having said open side, said housing blank comprising a rigid substrate, which defines said wall portions and is a formable material wherein the side walls are shaped to a non-rectangular shape along a shaped side edge thereof, said housing blank further comprising a finish layer overlying said substrate on an exterior side thereof opposite to an interior face and covering said side edge, said substrate having a variable thickness defined by thinner sections extending face-wise and thicker portions which project interiorly from said thinner sections to define mounting formations to which said mounting hardware is fixedly secured to thereby secure each said closure member to said housing blank and further define reinforcement sections at least along said shaped side edges of said side walls.

12. The composite storage cabinet according to claim 11, wherein said closure members have a shape corresponding to said shaped edges of said side walls.

13. The composite storage cabinet according to claim 12, wherein said shaped edges have a curvature along the vertical length thereof and said closure members have a corresponding curvature in the vertical dimension.

14. The composite storage cabinet according to claim 11, wherein said substrate is defined by a first layer which defines said thin sections and extends across the width of each of said wall portions, and a second layer disposed interiorly of said first layer wherein said second layer has a geometric pattern which partially covers said first layer to define said thicker sections, said thicker sections defining said mounting formations and further defining elongate reinforcement formations which rigidify and support the thinner sections.

15. The composite storage cabinet according to claim 14, wherein the finish layer is defined by a thin layer of finish material applied to said substrate when in the planar, unfolded condition.

16. The composite storage cabinet according to claim 15, said mounting hardware is fixedly secured to said housing blank when in said unfolded condition and said respective closure member is mounted to said mounting hardware when said housing blank is in said folded condition.

17. The composite storage cabinet according to claim 11, wherein said closure members are defined by openable drawers which are disposed in said interior compartment and enclose said open side when in a closed position, said mounting hardware for said drawers comprising drawer slides which are mounted to said mounting formations of said side walls, said mounting formations further including bosses which project interiorly of said thinner sections proximate said bottom wall, and said storage cabinet further including support members which project downwardly of said bottom wall and include connectors projecting upwardly through said bottom wall into fixed engagement with said bosses, said bosses being disposed on said side walls.

18. A method for forming a composite storage cabinet which comprises a housing defined by a plurality of cabinet walls including a bottom wall, upright side walls, an upright back wall and a top wall which define an interior compartment for storage and an open side for permitting access to said interior compartment, the method comprising the steps of:
providing a thin rigid substrate having a predefined shape which defines a plurality of interconnected wall portions wherein each of said wall portions corresponds to a respective one of said cabinet walls which is formed thereby, said substrate having a variable thickness defined by thinner sections extending face-wise and thicker portions which project interiorly from said thinner sections to define mounting formations;
finishing an exterior side of said substrate;
performing a material removal process to said substrate edgewise along common edges of adjacent pairs of said wall portions to define a respective fold line between each adjacent pair of said wall portions and form a housing blank wherein said fold lines permit folding of said housing blank from an unfolded condition wherein said wall portions are coplanar and a folded condition wherein said wall portions are folded about said fold lines to a box-like configuration having said open side;
installing mounting hardware on said housing blank in said unfolded condition wherein said mounting hardware is configured for mounting;
folding said wall portions about said fold lines to said folded condition; and
installing said closure members.

19. The method according to claim 18, wherein said finishing step comprises applying a finish layer of finish material to said substrate.

20. The method according to claim 19, wherein said finish layer is applied by bladder wrapping said substrate and edges thereof, said method further including the step of trimming any excess finish layer material from any of the substrate edges and openings in the substrate.

21. The method according to claim 19, which further includes the step of interlocking the wall portions together through appropriate adhesives and/or locking formations formed in the housing blank.

22. The method according to claim 19, which further includes the step of mounting casters to caster mounts formed in the housing blank to form a housing sub-assembly and then the housing sub-assembly may be oriented to an upright configuration for subsequent mounting of the closure members thereto.
